(19) United States
(12) Patent Application Publication
(10) Pub. No.: US 2005/0052533 A1
(43) Pub. Date: Mar. 10, 2005

(54) Object tracking method and object tracking apparatus

(75) Inventors: Wataru Ito, Kodaira (JP); Hirotada Ueda, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(73) Assignee: Hitachi Kokusai Electric Inc., Tokyo (JP)

(21) Appl. No.: 10/933,390

(22) Filed: Sep. 3, 2004

(30) Foreign Application Priority Data
Sep. 5, 2003 (JP) 2003-314263

(51) Int. Cl. H04N 7/18

(52) U.S. Cl. 348/169

(57) ABSTRACT

An object tracking method and an object tracking apparatus for tracking an object in an image based on an image signal obtained from an image pickup device. At least one of the feature amounts including the position, size and the moving distance of the object in the image is detected, and based on the detection result, the image pickup lens of the image pickup device is controlled thereby to track the object. At the same time, the range of a partial area of the image is set based on the detection result, and the image of the partial area thus set is enlarged to a predetermined size and displayed on a monitor.

### BACKGROUND OF THE INVENTION

The present invention relates to an object tracking method and an object tracking apparatus for tracking an object in an image picked up, or in particular to a technique for making it possible to track a moving object at a sufficiently high speed and acquire an image of the object with a sufficiently high resolution.

A remote monitor system having an image pickup device such as a TV camera has been widely used. In many cases, the remote monitor system is what is called a manned monitor system in which an operator monitors an object while watching the image displayed on the monitor. In the manned monitor system, the operator is required to constantly watch the image displayed on the monitor and identify in real time an intruding object such as a person and an automobile entering the monitor range. This poses a considerable burden on the operator.

In view of the fact that the concentration power of a person is limited, the manned monitor system may unavoidably overlook an intruding object and poses the reliability problem. With the explosive extension of the use of the monitor camera, on the other hand, a single operator is required to watch a multiplicity of TV camera images on a plurality of monitors on more and more occasions. An intruding object which is caught on a plurality of TV cameras at the same time is liable to be overlooked.

Such being the situation, a strong demand has recently arisen for a monitor system of what is called automatic tracking type capable of the monitor operation without human labor in which an intruding object is detected automatically by processing the image picked up by a TV camera, and a camera pan and tilt head (swivel base) carrying a TV camera is controlled to catch the image of the intruding object at the central part of the screen so that the direction of the visual field and the image angle are automatically adjusted to produce a predetermined notice and take an appropriate alarm action.

The implementation of this system, however, requires the function of detecting from an image signal what is considered as an intruding object and detecting the motion of the intruding object using a predetermined monitor system.

One example of the monitoring method widely used for detecting an intruding object in the manner described above is a subtraction method. In the subtraction method, the input image obtained from the TV camera is compared with a reference background image prepared in advance, i.e. an image in which no object to be detected appears. Then, the difference of brightness is determined for each pixel, and an area having a large difference value is detected as an object. An application of the subtraction method is also under study. See U.S. Pat. No. 6,088,468, for example.

The template matching method, which is also used as widely as the subtraction method, is another example of the conventional monitor method in which the moving distance of an intruding object is detected. In the template matching method, an image of an intruding object detected by the subtraction method, etc. is registered as a template, and the position most analogous to the template image is detected from a plurality of sequentially input images. See, for example, Tamura Hideyuki, “Introduction to Computer Image Processing”, Soken Publishing, 1985, p. 149-153. Normally, in the case where an object to be detected is tracked using the template matching method, the change in the position of the object is followed, and the image of the position of the object detected by matching is updated sequentially as a new template.

### SUMMARY OF THE INVENTION

A monitor system of object tracking type called the mechanical/optical tracking method is available in which the camera pan and tilt head (hereinafter referred to as the camera head) and the image pickup lens are mechanically and/or optically controlled. In the case where the processing unit such as the microprocessing unit (MPU) of the monitor system judges that the camera head or the image pickup lens is required to be controlled, however, some delay time occurs before the control operation is actually started. Also, the time required for controlling the camera head and the image pickup lens (the time before the camera head is controlled to an intended position or the image pickup lens is controlled to the focal length) may last as long as several seconds. During this time period, a plurality of frames of input images are processed by a processing unit.

This process is explained specifically with reference to FIG. 7. FIG. 7 shows an example in which a human-like intruding object 801a detected at a given time point t1 is tracked while being zoomed up. In FIG. 7, the time point at which the input image 801 is acquired is expressed as t1, and the time points at which the sequentially input images are acquired at a predetermined time interval (say, 100 ms) are expressed as (t1+1), (t1+2), . . . in the order of input.

First, the intruding object 801a in the input image 801a obtained at time point t1 is detected by the subtraction method. The image of the intruding object is registered as a template 801b. In view of the fact that the intruding object 801a is located on the left side of the center of the input image 801, an instruction to turn (pan) the camera head to the left is transmitted through a camera head control interface means. Further, in order to set the image of the intruding object to a predetermined size (say, 80% of the vertical size of the screen), an instruction to increase the focal length of the image pickup lens is transmitted through a lens control interface means.

Next, an intruding object 802a is detected by template matching from an input image 802 obtained at time point (t1+1), and this image is updated as a template 802b. By this time, the operation corresponding to the instruction transmitted at time point t1 is not yet completed for the camera head and the image pickup lens. In this case, a control instruction is again transmitted to the camera head and the image pickup lens.

Next, an intruding object 803a is detected by template matching from an input image 803 obtained at time point (t1+2), and this image is updated as a template 803b. In the process, the intruding object 803a is located at the center of the screen and therefore the control operation of the camera head is completed. Nevertheless, the size of the intruding object on the input image has yet to reach a predetermined target size. Once again, therefore, a control instruction is transmitted to the image pickup lens.

Next, an intruding object 804a is detected by template matching from an input image 804 obtained at time point (t1+3), and this image is updated as a template 804b. By that time point, the intruding object in the input image has reached the predetermined target size, and therefore the control operation of the image pickup lens is completed.

In this way, a delay occurs between the time of processing the result of detection of an intruding object by the processing unit and the control operation of the camera head and the image pickup lens. This low responsiveness may make it impossible for the camera head or the image pickup lens to follow the motion of the intruding object in the monitor area. In such a case, the intruding object cannot be caught within the visual field of the image pickup device, and therefore it is difficult to improve the object tracking performance. This problem presents itself conspicuously especially in the case where the image pickup lens has a large focal length (in zoom-in operation). In mechanical/optical tracking of an object, therefore, the focal length of the image pickup lens is required to be set at a small value for the purpose of monitoring.

In order to overcome this problem, an object tracking method called the electronic tracking method has bee proposed in which a part of the input image is electronically enlarged and tracked without controlling the camera head or the image pickup lens. In this method, a part of the input image is cut out and enlarged, and therefore the pseudo control operation of the camera head is realized by adjusting the cut-out position. Further, the lack of the mechanical control operation makes it possible to solve the above-mentioned problem of low responsiveness of the devices for controlling the mechanical/optical tracking operation, and therefore stable tracking operation is assured. In this method, however, a part of the input image is cut out and enlarged, and therefore in the case where the resolution of the input image is low, the enlarged image undesirably appears in blocks (mosaic).

This problem is explained specifically with reference to FIG. 8. FIG. 8 shows the result of processing the input image 901 (same as the input image 801) at time point t1 in the same manner as in the case explained with reference to FIG. 7. In FIG. 8, the input image 901 is electronically tracked so that a blocked image 902 of an electronically enlarged partial image 901c of the input image 901 is displayed on the image monitor device. In FIG. 8, with the increase in the electronic magnification, as shown by the image 902, it becomes impossible to obtain the information such as the detailed expression of the intruding object. Further, the electronic tracking requires that the image of the whole monitor area is picked up with an image pickup device without controlling the camera head or the image pickup lens, and therefore it is necessary to use an image pickup device having a large field angle.

In the monitor system of automatic tracking type, it is important to monitor an object at a maximum zoom-up rate without adversely affecting the reliability of the object tracking function. The mechanical/optical tracking method has the advantage that the monitor range is wide and the image of the intruding object can be acquired with a high resolution. On the other hand, this monitor system is encountered with the problem of a considerable time length required before the intruding object is caught in an appropriate size at the center of the screen due to the low responsiveness of the camera head and the image pickup lens and the problem that the object cannot be tracked any longer once displaced out of the image.

The electronic tracking system has the advantage that an intruding object can be caught at high speed in an the appropriate size at the center of the screen. On the other hand, the problem is that an increased magnification of the input image at a low resolution leads to a blocked image, thereby making it impossible to acquire the detailed information on the intruding object and necessitating a wide-angle image pickup device.

The object of this invention, which has been developed in view of the aforementioned situation, is to provide an object tracking method and an object tracking apparatus wherein an object can be automatically tracked by an image pickup device at a sufficiently high speed to follow the motion of the object and the image of the object can be acquired with a sufficiently high resolution.

According to one aspect of the invention, there is provided an object tracking method using an image pickup device capable of controlling the image pickup direction and the zooming rate, comprising the steps of: detecting at least one feature amount of an image of the object in an input image obtained from the image pickup device; controlling the image pickup device based on the detected feature amount to track the object; setting a range of a partial area containing the image of the object in the input image based on the feature amount detected; and enlarging the image in the set range of the partial area.

In this specification, the word “tracking” should be interpreted to have a similar meaning to the word “tracing” according to the invention. Also, the expression “image” used herein should be interpreted to include “video image” in similar fashion according to the invention. Further, the image as expressed herein is defined as a dynamic image in the form of a temporal image sequence, while a stationary image is defined as one frame of image included in a dynamic image, a part of the image included in one frame of the image or a still image other than the dynamic image.

Any of various types of devices such as a camera may be used as an image pickup device. Also, any of various types of image signals such as NTSC or PAL may be used. Also, an object may include any of various ones such as a person, a vehicle, an animal, etc. An object in an image corresponds to, for example, the image portion of the object contained in the image.

According to an embodiment, at least one feature amount described above includes at least one of the position, size and moving distance of the image of the object. Note that the “moving distance” is a distance traveled by the image of the object in a predetermined unit time.

According to an embodiment, the position of the range of the partial area is set based on the position of the image of the object, while the size of the range of the partial area is set based on the size of the image of the object.

According to an embodiment, the image included in the range of the partial area is enlarged at a magnification rate set based on the size of the range of the partial area and a predetermined image display size.

According to an embodiment, a upper limit of a zoom amount of the image pickup lens of the image pickup device is set based on the size of the image of the object detected, wherein the size of the range of the partial area is set to a preset ratio smaller than unity of the size of the input image.

According to an embodiment, the zoom amount of the image pickup device is changed in dependence on the moving distance of the image of the object.

According to an embodiment, the zoom amount of the image pickup device is changed in dependence on the size of the image of the object.

According to another aspect of the invention, there is provided an object tracking apparatus comprising: an image pickup device with the imaging direction and the zoom ratio thereof controllable; a display unit; a detection unit for detecting a feature amount of an image of the object within an input image obtained from the image pickup device; a control unit for controlling the image pickup device based on the feature amount detected to track the object; a setting unit for setting a range of a partial area including the object within the input image based on the feature amount; and an enlarging unit for enlarging an image in the set range of the partial area for display on the display unit.

According to still another aspect of the invention, there is provided a computer program used to track an object by operating an object tracking apparatus having an image pickup device with an imaging direction and zoom amount thereof controllable, by executing the steps of: detecting at least one feature amount of an image of the object within an image obtained from the image pickup device, the feature amount including at least one of a position, size and moving distance of the image of the object; controlling the image pickup device based on the feature amount detected to track the object; setting a range of a partial area including the image of the object within the input image based on the detected feature amount; and enlarging an image in the set range of the partial area.

According to yet another aspect of the invention, there is provided a computer program embodied on a computer-readable medium for use in tacking an object by operating an object tracking apparatus including an image pickup device an imaging direction and zoom amount thereof controllable, by executing the steps of: detecting at least one feature amount of an image of the object within an input image obtained from the image pickup device, the feature amount including at least one of a position, size and moving distance of the image of the object; controlling the image pickup device based on the detected feature amount to track the object; setting a range of a partial area including the image of the object within the input image based on the detected feature amount; and enlarging the image in the set range of partial area.

The above and other objects, features and advantages will be made apparent by the detailed description taken in conjunction with the accompanying drawings.

### BRIEF DESCRIPTION OF THE DRAWINGS

FIG. 1 is a diagram showing an example of the steps of the object tracking process executed by an image monitor device according to an embodiment of the invention.

FIG. 2 is a diagram showing an example configuration of an image monitor device according to an embodiment of the invention.

FIG. 3 is a diagram schematically showing an example of the process of detecting an intruder using the subtraction method and an example of the process of registering the image of the intruding object as a template.

FIG. 4 is a diagram showing an example of the flow of the process of tracking an intruding object by sequentially executing the process of detecting the moving distance of the intruding object according to the template matching method.

FIG. 5 is a diagram showing an example of the operation of controlling the camera head based on the position of an object detected.

FIGS. 6A and 6B are diagrams showing an example of the manner in which the template is enlarged or compressed.

FIG. 7 is a diagram schematically showing an example of the operation of controlling the camera head and the image pickup lens.

FIG. 8 is a diagram showing an example of the manner in which a part of an input image is electronically enlarged.

FIG. 9 is a diagram showing an example of the manner in which the process is executed to track an object by an image monitor device according to an embodiment of the invention.

FIG. 10 is a diagram showing an example of the manner in which a partial image is cut out.

FIG. 11 is a flowchart showing the steps of the object tracking process executed according to another embodiment of the invention.

FIG. 12 is a diagram for explaining an example of setting the zoom magnification of the image pickup lens according to the embodiment shown in FIG. 11.

### DESCRIPTION OF THE EMBODIMENTS

Embodiments of the invention are explained below with reference to the accompanying drawings. Identical or similar component parts are designated by the same reference numerals, respectively.

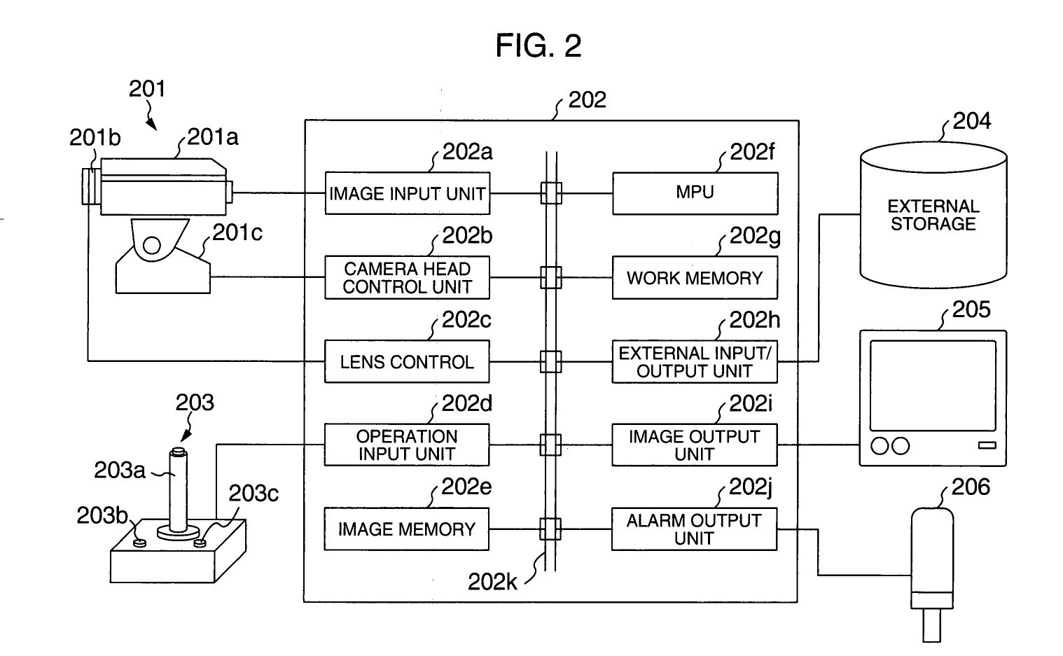

FIG. 2 shows an example of a hardware configuration of an image monitor device using an object tracking apparatus according to the invention. The image monitor according to this embodiment includes an image pickup device 201, a processing unit 202, an operating unit 203, an external storage unit 204, an image monitor 205 and an alarm lamp 206.

The image pickup device 201 includes a TV camera 201a, an image pickup lens 201b configured of a zoom lens, for example, and a camera head 201c configured of a swivel, for example.

The processing unit 202 includes an image input unit 202a, a camera head control unit 202b, a lens control unit 202c, an operating input unit 202d, an image memory 202e, a MPU 202f, a work memory 202g, an external input/output unit 202h, an image output unit 202i, an alarm output unit 202j and a data bus 202k.

The operating unit 203 includes a joystick 203a, a first button 203b and a second button 203c.

Specifically, the output of the TV camera 201a is connected to the data bus 202k through the image input unit 202a, the control unit of the image pickup lens 201b is connected to the data bus 202k through the lens control unit 202c, the camera head 201c with the TV camera 201a mounted thereon is connected to the data bus 202k through the camera head control unit 202b, and the output of the operating unit 203 is connected to the data bus 202k through the operating input unit 202d.

The external storage unit 204 is connected to the data bus 202k through the external input/output unit 202h, the image monitor 205 is connected to the data bus 202k through the image output unit 202i, and the alarm lamp 206 is connected to the data bus 202k through the alarm output unit 202j. The MPU 202f, the work memory 202g and the image memory 202e are directly connected to the data bus 202k.

The TV camera 201a catches a target monitor area in a predetermined visual field, picks up an image of the target monitor area and outputs an image signal. For this purpose, the TV camera 201a including an image pickup lens 201b is mounted on the camera head 201. The image signal picked up by the TV camera 201a is stored in the image memory 202e through the data bus 202k from the image input unit 202a.

The external storage unit 204 functions to store the program and the data, which are read into the work memory 202g through the external input/output unit 202h as required. On the other hand, the program and the data are stored in the external storage unit 204 from the work memory 202g.

The MPU 202f executes the process in accordance with the program stored in the external storage unit 204 and read into the work memory 202g at the time of operation of the processing unit 202 so that the image stored in the image memory 202e is analyzed in the work memory 202g. In accordance with the processing result, the MPU 202f controls the image pickup lens 201b through the lens control unit 202c or the camera head 201c through the camera head control unit 202b thereby to change the visual field of the TV camera 201a. At the same time, the MPU 202f displays the result of detecting an intruding object as an image on the image monitor 205 and turns on the alarm lamp 206 as required.

Regarding the image monitoring device described above, it is noted that the configurations of the image pickup device 201, processing unit 202 and so on and connections thereamong are not restricted to the present embodiment. For example, the image monitoring device may be configured such that the image pickup device 201 and processing unit 202 may be connected through a network, such as the Internet or that video signals picked up by the TV camera 201a may be digital-compressed and the resulted image data may be inputted to the processing unit 202.

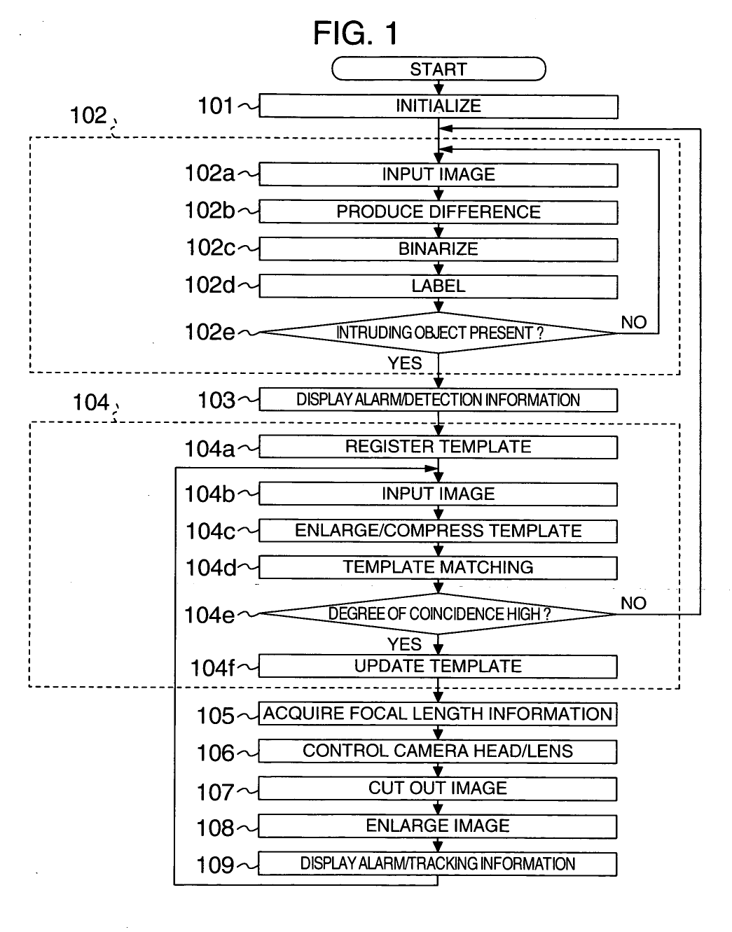

FIG. 1 shows an example of the steps executed in the object tracking process using the subtraction method and the template matching method by an image monitor device according to this embodiment. With reference to FIG. 1, the object tracking process is explained.

First, the image memory 202e and the work memory 203g for executing the object tracking process are initialized in the initialization step 101.

Next, the process 102 (steps 102a to 102e) for detecting an intruding object by the subtraction method is executed.

Specifically, in the first image input processing step 102a, an input image having 320 pixels in horizontal direction and 240 pixels in vertical direction, for example, is obtained from the TV camera 201a.

In the difference processing step 102b, the brightness difference for each pixel is calculated between the input image obtained in the first image input step 102a and the reference background image containing no intruding object prepared in advance.

In the binarization step 102c, the value of the pixel of which the difference pixel value of the difference image obtained in the difference processing step 102b is less than a threshold value Th is set to “0”, and the value of the pixel of which the difference pixel value of the difference image is equal to or more than the threshold value Th is set to “255” thereby to obtain a binary image. The predetermined threshold value Th is assumed to be 20, and the value of one pixel is assumed to be 8 bits (“0” to “255”), for example for the purpose of calculation.

In the labeling step 102d, a cluster of pixels having the pixel value “255” in the binary image obtained in the binarization step 102c is detected and each pixel is numbered for discrimination.

The intruding object presence judging step 102e judges that an intruding object is present in the target monitor area in the case where the cluster of pixels having the pixel value “255” numbered in the labeling step 102d meets predetermined conditions. The predetermined conditions are, for example, the size of 20 or more pixels in horizontal direction and 50 or more pixels in vertical direction.

In the case where the intruding object presence judging step 102e judges that an intruding object is present, the process proceeds to the alarm/detection information display step 103. In the case where the judgment is that no intruding object is present, on the other hand, the process proceeds again to the first image input processing step 102a thereby to execute the process of the subtraction method again.

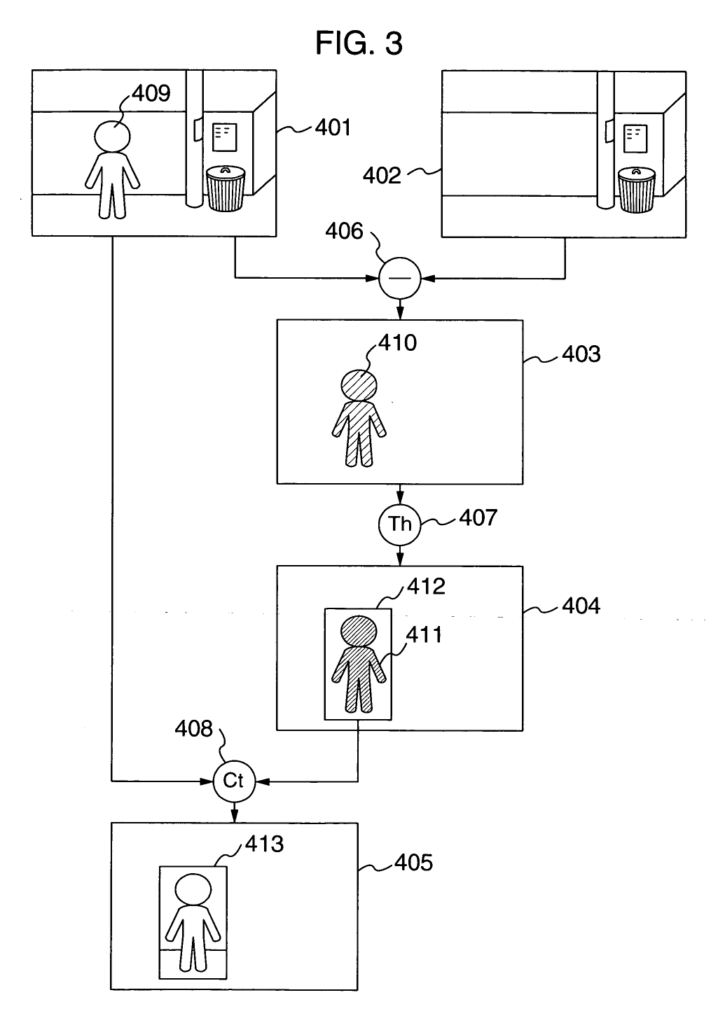

With reference FIG. 3, the process of detecting an intruding object is specifically explained. FIG. 3 schematically shows an example of the process of detecting an intruding object using the subtraction method and an example of the process of registering an image of the intruding object as a template.

In FIG. 3, numeral 401 designates an input image obtained in the first image input processing step 102a, and numeral 402 a reference background image prepared and recorded beforehand in the image memory 202e. Numeral 406 designates a subtractor for executing the process of the difference processing step 102b, numeral 403 a difference image obtained in the difference processing step 102b, and numeral 407 a binarizer for executing the binarization step 102c. Numeral 404 designates a binary image obtained in the binarization step 102c.

The subtractor 406 calculates the brightness difference of each pixel between the input image 401 and the reference background image 402 and outputs a difference image 403. Next, the binarizer 407 processes each pixel of the difference image 403 with respect to the threshold value Th, so that the pixel value less than the threshold Th is set to “0” and the pixel value not less than the threshold Th to “255” thereby to obtain a binary image 404. As a result, the human-like object 409 displayed in the input image 401 is calculated as an area (the area in which the image signal changes) 410 in which a difference is developed by the subtractor 406, and detected as an image 411 by the binarizer 407.

Next, the continuation of the process shown in FIG. 1 is explained. In the alarm/detection information display step 103, in order to send an alarm indicating the detection of an intruding object to the operator, for example, the information on the intruding object is displayed on the image monitor 205 through the image output unit 202j or the alarm lamp 206 is turned on through the alarm output unit 202j. The information on the intruding object may be the positions and number of persons, for example.

The input image with an intruding object superposed thereon may be displayed, for example, on the image monitor 205. The intruding object superposed on the input image is displayed in any of other various forms, i.e. directly as a binary image of the intruding object obtained in the binarization step 102c, as a circumscribed rectangle thereof or in the case where the intruding object is a person, with a triangular mark attached on his/her head or in a color.

Next, process 104 (steps 104a to 104f) for detecting the moivng distance of the intruding object by template matching is executed.

Specifically, in the template registration step 104a, the image of an intruding object in the input image is cut out and registered as a template based on the circumscribed rectangle 412 representing a cluster of pixels having the pixel value “255” numbered in the labeling step 102d.

In the second image input processing step 104b, like in the first image input processing step 102a, an input image having 320 pixels in horizontal direction and 240 pixels in vertical direction, for example, is obtained from the TV camera 201a. In the process, the focal length of the image pickup lens 201b of the TV camera 201a is set to f and recorded in the work memory 202g.

In the template enlargement/compression step 104c, the difference in size between the input image and the target object displayed in the template caused by the change in the focal length of the image pickup lens 201b is corrected in accordance with the ratio between the focal length f′ recorded in the work memory 202g, i.e. the focal length f′ of the image pickup lens 201b of the TV camera 201a at the time of the preceding execution of the template update processing step 104f described later and the present focal length f recorded in the work memory 202g. According to this embodiment, the image pickup lens 201b is controlled to change the focal length in the camera head/lens control step 105.

In the template matching step 104d, an image having the highest degree of coincidence with the template in the input image obtained in the second image input step 104b is detected. Normally, the comparison between the template and the whole input image consumes considerable time. Therefore, a predetermined range of a search area in the template is searched for an image having the highest degree of coincidence with the template.

In the coincidence degree judging step 104e, the degree of coincidence r(Δx, Δy) described later is determined using, for example, the normalized correlation value expressed by equation 1 described later. In the case where the degree of coincidence is 0.7 or more, for example, it is judged that the degree of coincidence is high and the process proceeds to the template update processing step 104f, while in the case where the degree of coincidence is less than 0.7, the process proceeds to the first image input processing step 102a described above.

A high degree of coincidence is indicative of the fact that the input image contains an image analogous to the template, i.e. that an intruding object is located in the monitor area at the position (Δx, Δy) as relative to the template position (x0, y1) described later. This process is followed by detecting the moving distance of the intruding object. A low degree of coincidence, on the other hand, is indicative of the fact that no image analogous to the template is existent in the input image, i.e. that no intruding object is present in the monitor area. In this case, the process proceeds to the first image input processing step 102a to detect an intruding object again by the subtraction method.

In the template update processing step 104f, the input image obtained in the second image input processing step 104b is cut out as a new template image based on the newly determined position of the intruding object. By updating the template as required in this way, the latest image of the intruding object is recorded in the template. Even in the case where the intruding object changes the position, therefore, the moving distance of the intruding object can be steadily detected.

With reference to FIGS. 6A, 6B, the template enlargement/compression processing step 104c is specifically explained. FIGS. 6A, 6B show the case in which the template is enlarged. Nevertheless, the principle is the same for the compression of the template.

FIG. 6A shows an example of the image 701 before enlarging the template, and FIG. 6B an example of the image 703 after enlarging the template. The zoom magnification r of the template is expressed as
r=f/f′ (1)

In the case where the focal length f′ of the image pickup lens 201b of the TV camera 201a at the time of executing the template update processing step 104f is 20 mm and the present focal length f is 24 mm, for example, r=24/20=1.2. This indicates that the size of the object on the image is enlarged by 1.2 times due to the change of the focal length of the image pickup lens 201b. In other words, by setting the template at the same center positions 702, 704 before and after enlargement, increasing the size of the template 701 to 1.2 times as large and using the resulting value as a new template 703, the size of the intruding object in the input image can be rendered coincident with the size of the intruding object in the template.

In the X-Y orthogonal coordinate system shown in the case of FIGS. 6A, 6B, the length (r×Tx) resulting from multiplying the X-direction Tx of the template 701 before enlargement by the zoom magnification r is set as the X-direction length of the template 703 before enlargement. In similar fashion, the length (r×Ty) resulting from multiplying the Y-direction length Ty of the template 81 before enlargement by the zoom magnification r is set as the Y-direction length of the template 703 after enlargement. In the process, the center positions 702, 703 of the templates 701, 703 are kept unchanged.

Immediately after detecting the intruding object in the intruding object detection process 102, the template update processing step 104f is not executed, and the focal length f′ of the image pickup lens 201b of the TV camera 201a at the time of updating the template is not acquired. In this case, therefore, the template enlargement/compression processing step 104c is not executed.

In the case where the template enlargement/compression processing step 104c is executed as in this example, on the other hand, the focal length f′ recorded in the work memory 202g is updated using the present focal length f of the image pickup lens 201b of the TV camera 201a at the time of execution of the template update processing step 104f.

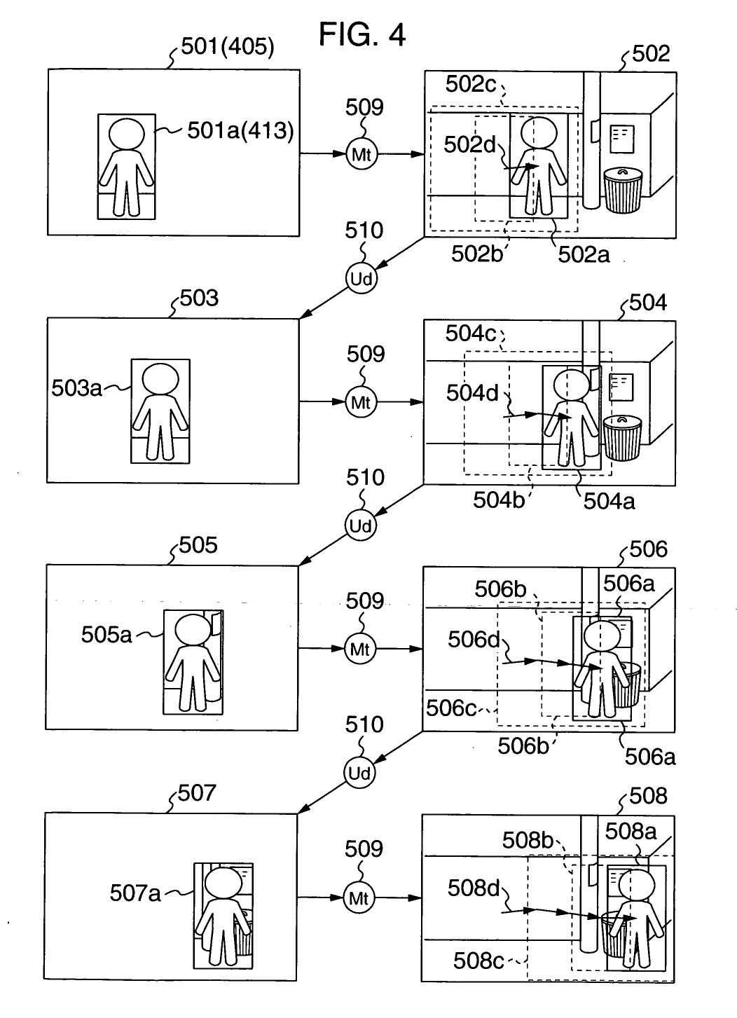

With reference to FIGS. 3 and 4, the process of detecting the moving distance of the intruding object is specifically explained. FIG. 3 shows a cut-out device 408 and a template image 405.

The intruding object displayed in the input image 401 is cut out by the cut-out device 408 based on the circumscribed rectangle 412 of the intruding object 411 obtained as a cluster of pixel values “255” in the binary image in the labeling step 102d described above thereby to obtain a template image 405. The template image 405 contains the template 413 of the intruding object 409, which template 413 constitutes an initial template in the process of detecting the moving distance of the intruding object according to the template matching method. Then, the template matching is executed based on the initial template.

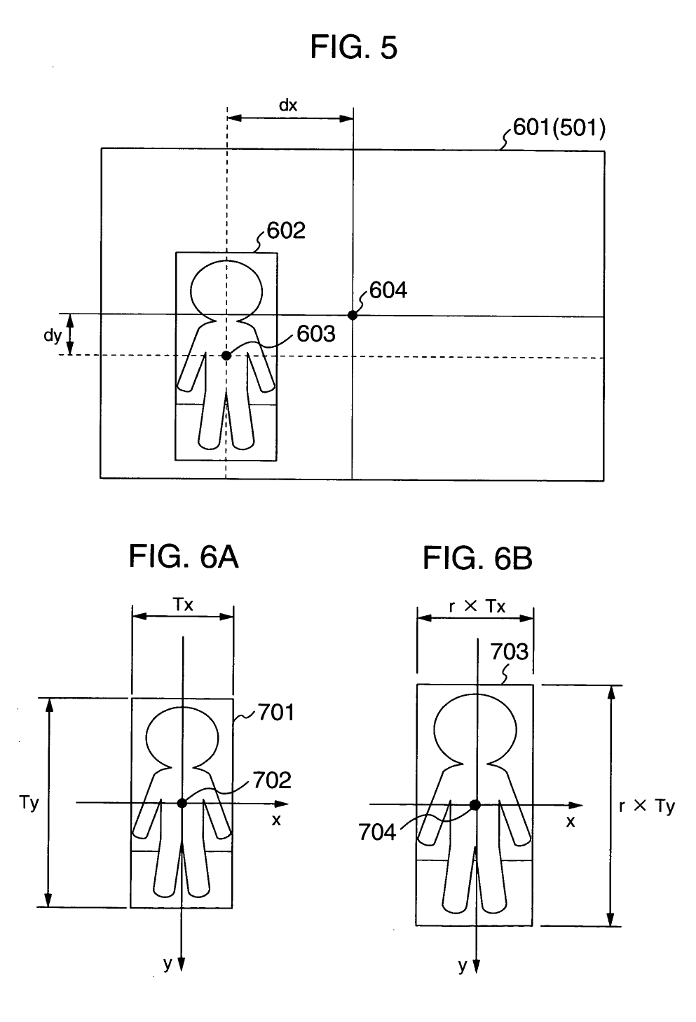

FIG. 5 schematically shows an example of the flow of the process for tracking an intruding object by executing, as required, the process of detecting the moving distance of the intruding object by template matching.

In FIG. 4, the time point at which the template image 501 is obtained is given as t0, and the time points at which the input images sequentially input at predetermined time internals (say, 100 ms) are given as (t0+1), (t0+2), and so forth in the order of input.

In FIG. 4, numeral 501 designates the template image at time point to. This template image 501 contains the template 501a as of the time point to. These templates are identical with the template image 405 and the template 413 shown in FIG. 3.

Numeral 502 designates an input image as of time point (t0+1). In this input image 502, the rectangular area 502b indicates the position of the intruding object at time point t0 (the position of the template 501a) and the rectangular area 502c an for template matching (search area).

Once the template matching process 509 (step 104d) is executed, the maximum degree of coincidence is reached by the image 502a having the highest degree of coincidence with the template 501a in the template matching search area 502c, thereby indicating the presence of the intruding object in the image 502a at time point (t0+1). This position is expressed as (Δx, Δy) as relative to the position (x0, y1) of the template 501a at time point to. Thus, the intruding object is seen to have moved by the distance indicated by arrow 502d.

In the template update process 510 (step 104f), the image 502a having the highest degree of coincidence with the template 501a is updated as a new template at time point (t0+1). Specifically, as shown in FIG. 4, the position 502a of the intruding object is cut out from the input image 502 as a template image 503, and the image 502a of the intruding object is updated as a new template 503a at time point (t0+1).

This process is executed for the input images sequentially applied from the TV camera 201a. Specifically, as shown in FIG. 4, a search area 504c is set in the input image 504 based on the position 504bof the template 503a at time point (t0+2), and the position 504a of the intruding object is detected by the template matching process 509 (step 104d) using the template 503a in the template image 503 at time point (t0+1). As a result, the intruding object is seen to have moved as indicated by arrow 504d.

Further, as shown in FIG. 4, the template image 505 and template 505a of the intruding object at time point (t0+2) are updated by the template updating process 510 (step 104f).

Also, as shown in FIG. 4, a search area 506c is set in the input image 506 at time point (t0+3) based on the position 506b of the template 505a, and the position 506a of the intruding object is detected by the template matching process 509 (step 104d) using the template 505a in the template image 505 at time point (t0+2). Then, the intruding object is seen to have moved as indicated by arrow 506d.

Further, as shown in FIG. 4, the template image 507 and the template 507a of the intruding object at time point (t0+3) are updated by the template updating process 510 (step 104f).

Also, as shown in FIG. 4, a search area 507cis set in the input image 508 at time point (t0+4) based on the position 508b of the template 507a, and the position 508a of the intruding object is detected by the template matching process 509 (step 104d) using the template 507a in the template image 507 at time point (t0+3). Then, the intruding object is seen to have moved as indicated by arrow 508d.

By sequentially executing the template matching process in this way, the intruding object can be tracked.

The search area and the degree of coincidence in the template matching process (step 104d) described above are explained specifically. The range of the search area is determined, for example, by the motion, on the input image, of a target object registered in the template.

As a specific example, assume that a ⅓-inch CCD (image pickup element 4.8 mm×3.6 mm in size) is used as an image pickup device 201, the focal length of the image pickup lens 201b is 32 mm and the distance to the object is 30 m. In the case where an image is picked up under this condition, the horizontal visual field of the TV camera 201a is 30×4.8−32=4.5 m. In the case where an image of an intruding object moving at the speed of 5 km per hour (about 1.39 m/s) is picked up by this TV camera 201a with an image size of 320×240 pixels and an input interval of 0.1 s (100 ms), the moving distance of the object on the image for each input image in horizontal direction is given as 320×1.39×0.1/4.5÷9.88 pixels.

Also, in the case where the object moves toward the TV camera 201a, the distance covered on the image is also increased, and therefore the actual range of the search area is set with a margin about five times as large as the calculated value. Specifically, assuming that the horizontal size Mx of the search area is 50 pixels, the vertical size My of the search area, which is changed depending on the angle of elevation and the mounting position of the TV camera 201a, assumes a value about 40% of the horizontal size. The search range in this case, therefore, is widened by Mx of 50 pixels in horizontal direction and My of 20 pixels in vertical direction on the template.

On the other hand, the degree of coincidence is expressed by equation (2) below, for example, using the normalized correlation value r(Δx, Δy)

$$r ( Δ x , Δ y ) = \frac{\begin{matrix}\begin{matrix}{\sum }_{i , j ∈ D}^{} \{ f ( x0 + Δ x + i , y0 + Δ y + j ) - \\ \overline{f ( x0 + Δ x , y0 + Δ y ) \}} \cdot \end{matrix} \\ \{ g ( x0 + i , y0 + j ) - \overline{g ( x0 , y0 )} \}\end{matrix}}{\sqrt{\begin{matrix}{\sum }_{i , j ∈ D}^{} \{ ( f ( x0 + Δ x + i , y + Δ y + j ) - \\ {( \overline{f ( x0 + Δ x , y0 + Δ y ) \}} )}^{2}\end{matrix}} \cdot \sqrt{{\sum }_{i , j ∈ D}^{} \{ g ( x0 + i , y0 + j ) - {\overline{g ( x0 , y0 ) \}}}^{2}}} \\ \overline{f ( x0 + Δ x , y0 + Δ y )} = \frac{1}{\vert D \vert} {\sum }_{i , j ∈ D}^{} f ( x0 + Δ x + i , y0 + Δ y + j ) \\ \overline{g ( x0 , y0 )} = \frac{1}{\vert D \vert} {\sum }_{i , j ∈ D}^{} g ( x0 + i , y0 + j ) \qquad ( 2 )$$

where f(x,y) indicates the input image. Referring to FIG. 5, g(x,y) indicates the template image 601, (x0, y1) the coordinate at the upper left part in the template 602, and D the size of the template. In this example, the coordinate axes of the image have the origin (0,0) at the upper left corner. Referring to FIG. 3, D corresponds to the size of the circumscribed rectangle 412 of the intruding object detected in the binary image 404, which in this case is equivalent to 50 pixels in horizontal direction and 20 pixels in vertical direction.

The normalized correlation value r (Δx,Δy) assumes a value defined as −1≦r(Δx,Δy)≦1, or 1 in the case where the input image is in complete coincidence with the template.

In the case where Δx, Δy are scanned in the search area for template matching, i.e. in the case where Δx and Δy are changed in the range −Mx≦Δx≦Mx, −≦My≦Δy≦My, respectively, in the aforementioned case, the process is executed to detect the position (Δx, Δy) associated with the maximum normalized correlation value r(Δx,Δy).

Next, the continuation of the processing steps shown in FIG. 1 is explained. In the focal length information acquisition step 105, the focal length f of the image pickup lens 102b at the time of acquisition of the present input image recorded in the work memory 202g is acquired.

Next, in the camera head/lens control step 106, the camera head 201c is controlled in accordance with the displacement between the center of the input image and the position of the intruding object detected by the template matching step 104d in the intruding object moving distance detection process 104. Also, in accordance with the size of the detected intruding object on the image and the corresponding focal length (acquired in step 105) of the TV camera 201a, a new focal length (zoom magnification) is calculated to control the focal length (zoom) of the image pickup lens 201b. The calculation of the zoom magnification is explained later.

With reference to FIG. 5, the process of controlling the camera head 201c described above is specifically explained. As an example, assume that an intruding object has been detected at the position 602 on the template image 601, as shown in FIG. 5. In this case, assuming that the center of the intruding object is located at the center position 603 of the template, the displacement dx along X axis and the displacement dy along Y axis from the center 604 of the template image 601 can be calculated.

In the case where the center position 603 of the template is located at least a predetermined amount s leftward (dx<−s) from the center 604 of the input image, the camera head 201c is panned to the left, while in the case where the template center position 603 is located at least a predetermined amount s rightward (dx>s), on the other hand, the camera head 201c is panned to the right. Also, in the case where the template center position 603 is located at least a predetermined amount s (dy<−s) upward of the center 604 of the input image, the camera head 201c is tilted upward, while in the case where the template center position 603 is located at least a predetermined amount s downward (dy>s) of the center 604 of the input image, on the other hand, the camera head 201c is tilted downward.

The use of the predetermined amount s eliminates the need of controlling the camera head 201c in the case where the intruding object is located at about the center of the image, and therefore the position of the intruding object at which to start controlling the camera head 201c can be designated by the predetermined amount s. Any of various values can be used as the predetermined amount s leftward, rightward, upward and downward, respectively. For example, the same value s may be employed for the four directions, or an arbitrary value s may be used for each of the four directions.

As an example, a predetermined amount s of 50 can be used in four directions of leftward, rightward, upward and downward. The smaller the predetermined amount s, the higher the likelihood of the image of the intruding object becoming difficult to see, because in response to a slightest displacement of the intruding object from the center, the camera head 201c is controlled. Nevertheless, the value such as 0 or a small value can be used as the predetermined amount s.

Also, the control speed of the pan motor and the tilt motor can be changed according to the absolute value of the X-axis displacement dx or the Y-axis displacement dy of the intruding object with respect to the center 604 of the template image 601. In this case, the larger the displacement dx along X axis or the displacement dy along Y axis, the higher the control speed.

Next, the process of controlling the image pickup lens 201b is explained specifically. In controlling the image pickup lens 201b, the image pickup lens 201b is zoomed up, for example, in the case where the height of the template is less than a predetermined value (or not more than a predetermined value) based on the size of the detected intruding object on the image, i.e. the size of the template, while the image pickup lens 201b is zoomed out in the case where the template height is not less than the predetermined value (or more than the predetermined value). As an example, the predetermined value can be 400 pixels (in the case where the size of the input image is 640 pixels in horizontal direction and 480 pixels in vertical direction). In this case, for example, assume that the present template height is 300 pixels and the present focal length f of the zoom lens 201b recorded in the work memory 202g is 30 mm. Then, for the height of the template to be 400 pixels, the focal length f of the zoom lens is set to 40 mm (=30×(400/300)). In other words, the zoom ratio is set to 1.3 times as large. Thus, the MPU 202f controls the focal length of the zoom lens 201b at 40 mm through the lens control unit 202c. By doing so, the intruding object can be caught in appropriate size within the visual field of the TV camera 201a. As an alternative, the zoom lens 201b can be controlled by a simple process in which the focal length is lengthened by 1.0 mm for zoom-in mode and shortened by 1.0 mm for zoom-out mode. The process of tracking an intruding object is repeatedly executed from to time, and therefore even this simple process can secure a similar control operation in the next frame as in the preceding frame in the case where the focal length is not sufficiently controlled. By repeating the process of tracking an intruding object, therefore, the focal length of the zoom lens 201b is controlled at a proper value and the height of the template can be set to a predetermined value. The change rate 1.0 mm of the focal length is empirically calculated. In the case where this value is large, the over-damping of the focal length may occur at about the proper value although the template can be set quickly to a predetermined height. With a small change rate of the focal length, on the other hand, a considerable time may be required before the template is set to a predetermined height due to the possible under-damping.

In the example described above, the template height is used to judge the size of the target object on the image. This is by reason of the fact that an intruding object is displayed in vertical position in most cases while the image input by the image pickup device 201 is horizontally long. Specifically, comparison of the sizes between the intruding object, caught in the visual field of the image pickup device 201, and the input image shows that the difference between the vertical lengths of the intruding object and the input image is smaller than the difference between the horizontal lengths thereof. In the case where the image pickup lens 102b is controlled for zoom-in operation based on the result of the size judgment using the template width, therefore, the vertical position of the intruding object may be undesirably displaced out of the visual field.

In evaluating the size of an intruding object on the image with the focal length of the image pickup lens 102b adjusted with reference to the height of the template, for example, the camera head 201c can be controlled steadily while at the same time making the zoom-up or zoom-out operation. The focal length of the image pickup lens 102b can be adjusted with reference to the width as well as the height of the template. In the case where the intruding object is a horizontally long object like an automotive vehicle, the template width can be used.

As a result, the intruding object can be tracked by being caught at the center of the visual field of the TV camera 201a, while at the same time controlling the camera head 201c automatically.

Also, it is possible to control the image pickup lens 201b based on the factors, other than the size of the intruding object on the image, such as the distance covered by the intruding object on the image. Specifically, in the case where the distance covered by the intruding object on the image is less than a predetermined value (or not more than a predetermined value), the image pickup lens 201b is zoomed in, while in the case where the distance covered by the intruding object on the image is not less than a predetermined value (or more than a predetermined value), on the other hand, the image pickup lens 201b is zoomed out. This operation of controlling the image pickup lens 201b based on the distance covered by the intruding object on the image is explained later with reference to another embodiment.

In the image cut-out processing step 107 and the image enlargement processing step 108 described below, the range of a partial area including the image of an intruding object is set in the input image and the image of the partial area in the set range is processed (enlarged).

First, in the image cut-out processing step 107, a partial image of the input image is cut out (the position, size, etc. of the partial image are set) in accordance with the position of the intruding object and the size of the template.

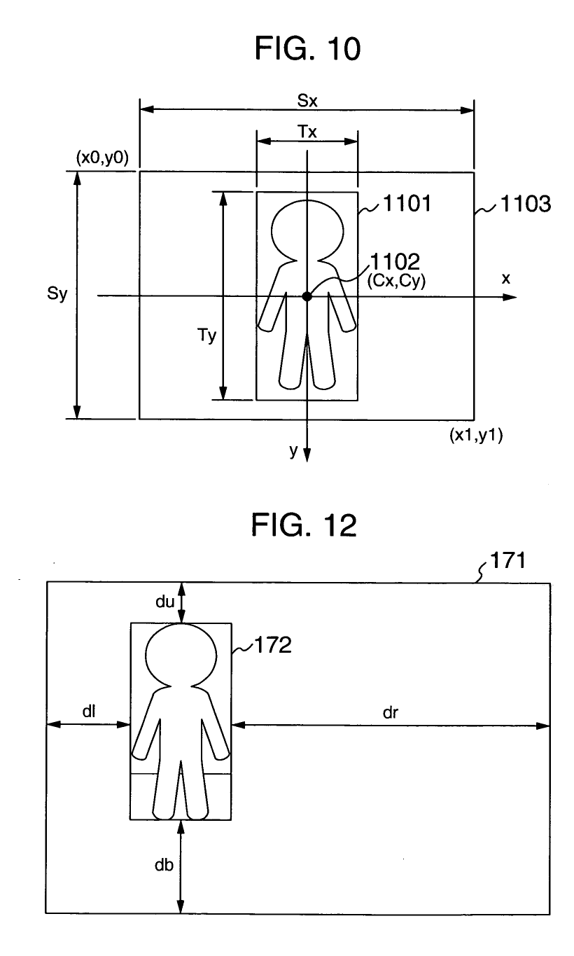

With reference to FIG. 10, the process of cutting out a partial image is explained specifically. FIG. 10 shows the relation between a template 1101 of an intruding object detected in the input image at a given time point and a partial image 1103 to be cut out. In FIG. 10, the size of the partial image, i.e. the number of pixels Sx in horizontal direction and the number of pixels Sy in vertical direction are expressed as
Sy=Ty×1.2 Sx=Sy×4/3 (3)
where Tx is the horizontal size (width) of the template, and Ty the vertical size (height) of the template. In the case shown by equation (3), the height Sy of the partial image is set at 120% of the vertical size Ty of the template. The value 120% is only an example, and 80% or a smaller value than the vertical size Ty of the template can alternatively be set as the height Sy of the partial image with equal effect.

The width Sx of the partial image, on the other hand, is set in accordance with the aspect ratio of the image monitor 205 which outputs the result of enlargement, as an example. In the case where the aspect ratio of the image monitor 205 is 4 to 3, for example, as seen from equation (3), the width Sx of the partial image is set to 4/3 times the height Sy of the partial image set as above.

In FIG. 10, the partial image cut-out range 1103 is set with the coordinate (Cx, Cy) of the template center as a reference. Specifically, in FIG. 10, the coordinate (x0, y1) of the upper left corner of the partial image cut-out range range 1103 is set to (Cx−Sx/2, Cy−Sy/2), and the coordinate (x1, y1) of the lower right corner of the partial image cut-out range range 1103 is set to (Cx+Sx/2, Cy+Sy/2). By doing so, the center of the template can be rendered to coincide with the center of the partial image.

The size (height and width) of the partial image is, though set with the vertical size Ty of the template as a reference in equation (3) above, may alternatively be set with the horizontal size Tx of the template as a reference.

Next, the continuation of the process shown in FIG. 1 is explained. In the image enlargement processing step 108, the partial image obtained in the image cut-out processing step 107 is enlarged to a sufficient size to be output to the image monitor 205. More specifically, the size of the image signal to be output can be set to a desired size in accordance with the screen size of the image monitor 205 or the like. In the case where the image monitor 205 is capable of outputting an image signal of NTSC system, for example, the partial image is enlarged to the size of 640 pixels in horizontal direction and 480 pixels in vertical direction. In this case, the magnification is 640/Sx in horizontal direction and 480/Sy in vertical direction. Nevertheless, various magnifications can be used. Also, an upper or lower limit can be set to each magnification. While in the above example the image was enlarged to a fixed size of 640 pixels in horizontal direction and 480 pixels in vertical direction, the image size after enlargement may not be a fixed size. The image thus enlarged is displayed on the image monitor 205 in the alarm/tracking information display processing step 109 described later.

Next, in the alarm/tracking information display processing step 109, the image enlarged in the image enlargement processing step 108 is displayed on the image monitor 205 through the image output unit 202i. Also, in order to warn the operator that an intruding object is being tracked, for example, the information on the intruding object is displayed on the image monitor 205 through the image output unit 202i or the alarm lamp 206 is turned on through the alarm output unit 202j. The information on the intruding object includes the moving distance and the route of movement.

As described above, according to this embodiment, the low responsiveness of the camera head and the image pickup lens in the mechanical or optical tracking process is compensated for by the electronic image cut-out process (step 107) and the image enlarging process (step 108), the requirement of a wide field angle for the electronic tracking process is met by the mechanical camera head control process (step 106), and the low resolution is compensated for by the optical image pickup lens control process (step 106). In this way, while the image of an intruding object is caught at the center of the image, the tracking process can be executed by outputting the image to the image monitor with a maximum resolution.

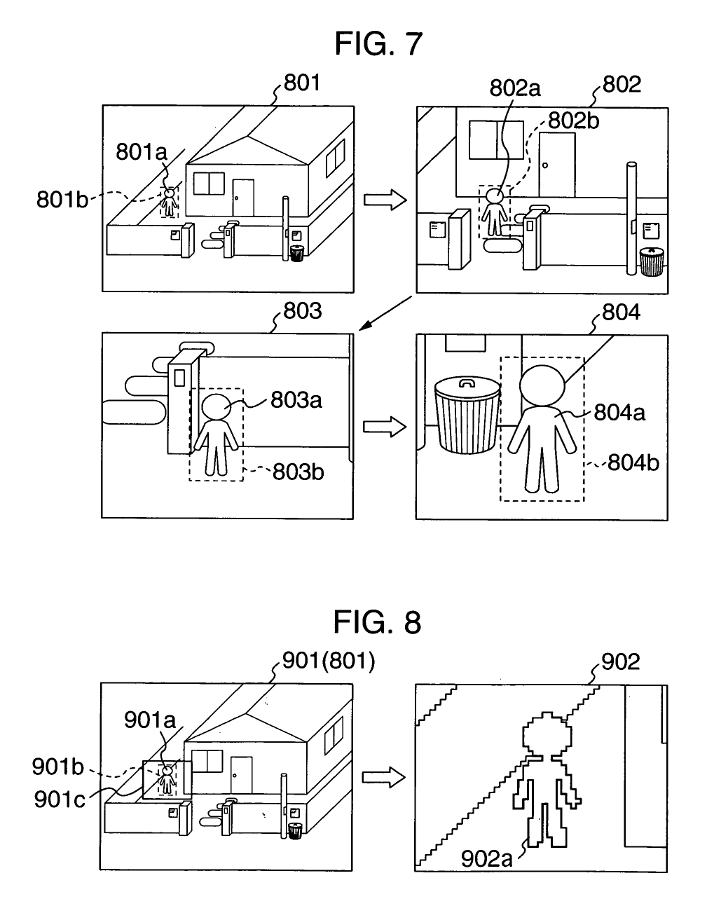

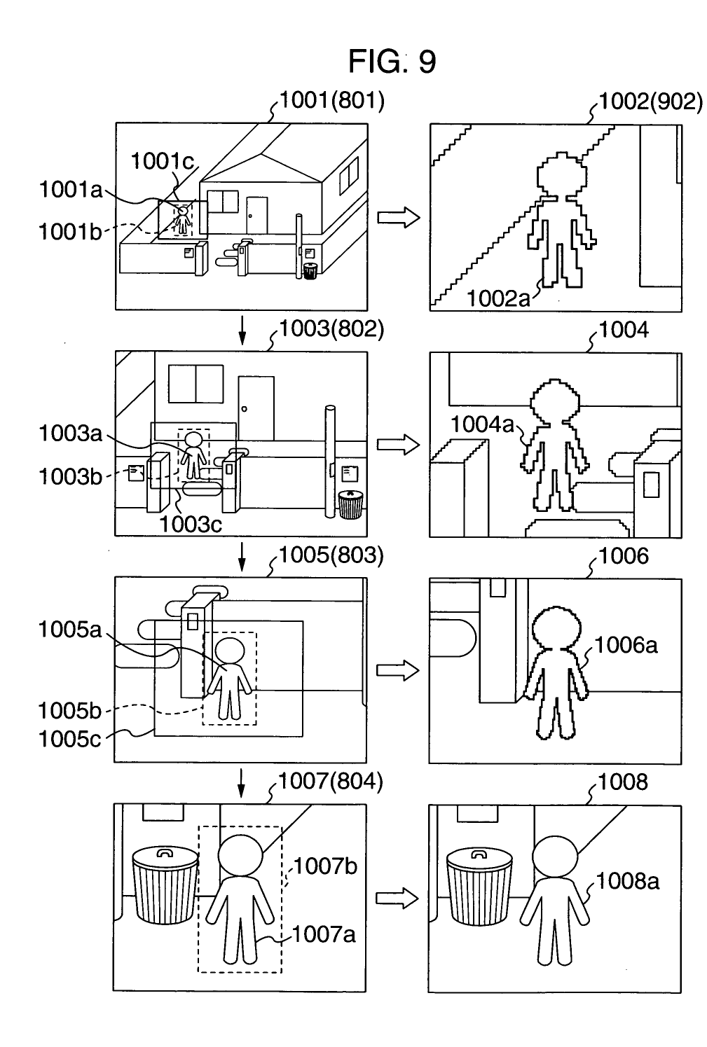

Next, the effects of this embodiment are explained specifically with reference to FIG. 9. FIG. 9 shows an example of an application of this embodiment to the image input at the same time as the result of the intruding object tracking process shown in FIG. 7. In FIG. 9, the images input at time points t1, (t1+1), (t1+2), (t1+3) are designated as 1001, 1003, 1005, 1007 (like the input images 801, 802, 803, 804), respectively, and the result of enlarging the partial image output to the image monitor 205 at these time points are designated as 1002, 1004, 1006, 1008, respectively.

In FIG. 9, the positions 1001a, 1003a, 1005a, 1007a of the intruding object and the templates 1001b, 1003b, 1005b, 1007b are the same as the positions 801a, 802a, 803a, 804a of the intruding object and the templates 801b, 802b, 803b, 804b of the template, respectively, in FIG. 8.

In FIG. 9, the input image 1001 is obtained and the intruding object 1001a is detected at time point t1. At the same time, the partial image 101c is cut out in accordance with the template 1001b of the intruding object in the image cut-out process (step 107). In the image enlarging process (step 108), the partial image 1001c is enlarged for display on the image monitor 205. Then, the display result 1002 is displayed in the image monitor 205. At the same time, the intruding object is displayed at the center of the screen as designated by 1002a (step 109).

Next, at time point (t1+1), the partial image 1003c is cut out (step 107), enlarged (step 108) and displayed on the image monitor 205 as the display result 1004 (step 109). Further, at time point (t1+2), the partial image 1005 is cut out (step 107), enlarged (step 108) and displayed as the display result 1006 (step 109). At time point (t1+3), the partial image cut out is as large as the input image, and therefore the input image 1007 directly constitutes the display result 1008.

In order to make sure that the partial image cut out is always smaller than the input image, the size of the partial image cut out can be set to 60%, for example, of the size of the input image. At the same time, the image pickup lens 201b was controlled using the height of the template of 400 pixels, for example, as an upper limit value of zoom-in operation. Nevertheless, a smaller value such that the height of the template becomes one half of the height of the input image, i.e. the value of 240 pixels may be used alternatively as the zoom-in upper limit. In this case, the partial image is necessarily required to be enlarged in the image enlarging step 108 described above. However, since the input image is large as compared with the partial image cut out (as large as the template), the distances from the upper, lower, left and right ends of the intruding object to the upper, lower, left and right ends of the input image, respectively, can be increased. This reduces the chance of encountering the problem that the upper, lower, left or right part of the intruding object may be displaced out of the visual field on the input image, and therefore the intruding object tracking performance can be improved. Also, the intruding object can be tracked by changing the position at which the partial image is cut out, in accordance with the movement of the intruding object, and therefore a high responsiveness to the movement of the object is realized.

By correcting the position of the cut-out partial image with the moving distance (Δx, Δy) of the intruding object, the intruding object can be tracked while following the movement thereof, thereby reducing the chance of overlooking the intruding object on display. In this case, the coordinate (x0, y1) of the upper left corner of the partial image cut-out range 1103 is given as (Cx−Sx/2+Δx, Cy−Sy/2+Δy), and the coordinate (x1, y1) at the lower right corner of the partial image cut-out range 1103 is given as (Cx+Sx/2+Δx, Cy+Sy/2+Δy).

According to this invention, therefore, the effect of low responsiveness of the camera head and the image pickup lens is suppressed, while the intruding object detected is caught at the center of the screen, and an image can be displayed with the progressively high resolution of the intruding object in accordance with the change in the focal length of the image pickup lens.

In the process shown in FIG. 10, the image cut-out position is determined with the template center as a reference. Nevertheless, a point other than the center of the template, such as above the template center, can be set as a reference to execute the process of cutting out the partial image. In the process, the template may be displaced out of the display zone. In view of the fact that the image to be processed by the processing unit is the one before being cut out, however, the object tracking process can be continued. In the case where a reference is set above the center of the template, for example, a partial image with the face of the intruding object as the center is obtained. Also, once only the neighborhood of the face of the intruding object is cut out as a partial image, an image with only the face of the intruding object enlarged can be output to the image monitor 205.

According to this embodiment, the image enlarging step 108 is executed in such a manner as to maintain a predetermined size of the intruding object on the image displayed on the image monitor 205. Nevertheless, in the case where the image of the intruding object on the input image is small, the resolution of the image displayed may be considerably deteriorated by the image enlarging process. In such a case, the lower limit of the width Sx and the height Sy of the partial image may be set in the partial image cut-out processing step 107. Assume that the lower limit of the width Sx and the height Sy of the partial image are set to the size equivalent to 160 and 120 pixels, respectively, for example. The maximum magnification in the image enlarging step 108 is given as 640/Sx=640/160=4, 480/Sy=480/120=4, respectively. Thus, the image is not enlarged by more than four times. Therefore, although the size of the displayed image of the intruding object is not constant, the reduction in the resolution of the displayed image can be suppressed.

In addition to the partial image enlarged by the image enlarging step 108, an image not electronically enlarged, i.e. the input image processed through the image input process 102a, 104b can be displayed on the image monitor 205. At the same time, the input image and the enlarged partial image can be displayed in juxtaposition on the image monitor 205. As an alternative, a compressed input image may be displayed in superposition on an enlarged partial image.

Another embodiment of the invention is explained below.

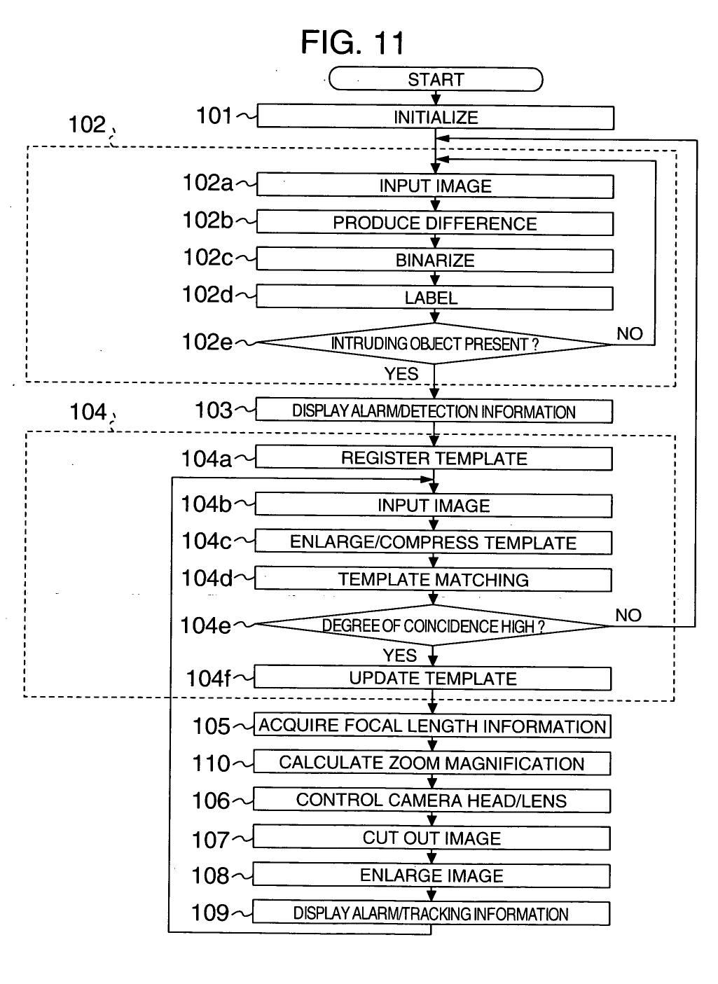

According to this invention, the image pickup lens 201b can also be controlled also based on the factors, other than the size of the intruding object on the image, such as the moving distance of the intruding object on the image. According to this embodiment, the image pickup lens 201b is controlled based on the moving distance of the intruding object on the image. Specifically, in the case where the moving distance of the intruding object on the image is less than a predetermined value (or not more than the predetermined value), the image pickup lens 201b is zoomed in, while in the case where the distance covered by the intruding object on the image is not less than the predetermined value (or more than the predetermined value), the image pickup lens 201b is zoomed out. This process is explained below with reference to FIGS. 11 and 12.

FIG. 11 shows another example of the steps of the object tracking process using the subtraction method and the template matching method in the image monitor device shown in FIG. 2. In FIG. 11, the process of steps 101 to 104 (and 105) is similar to that shown in FIG. 1 and therefore not explained again. FIG. 12 is a diagram for explaining an example of setting the zoom magnification according to this embodiment.

As in FIG. 1, the focal length f of the image pickup lens 201b at the time of acquisition of the present input image recorded in the work memory 202g is acquired in step 105.

Next, the zoom magnification rf is calculated (step 110) from equation (4) based on the moving distance (Δx, Δy) of the intruding object obtained in the template matching process (step 104).

$$rf = ( \begin{matrix}\frac{Kx}{Δ x} & ( \frac{Δ x}{Mx} \geq \frac{Δ y}{My} , Δ x \neq 0 ) \\ \frac{Ky}{Δ y} & ( ( \frac{Δ x}{My} > \frac{Δ y}{Mx} , Δ y \neq 0 ) \\ 1.5 & ( Δ x = Δ y = 0 )\end{matrix} \qquad ( 4 )$$

In equation (4), Mx, My designate the search range in the template matching method as already explained, and Kx, Ky designate the maximum moving distance of the intruding object on the image that can be tracked steadily, which are about one half of the search range, i.e. Kx=25, Ky=10 for Mx=50, My=20 in the case under consideration. The values of Kx and Ky assume a value of about one half of the search range sufficient to meet the requirement to give as much margin as to avoid the displacement of the object from the search range. Actually, however, the values Kx, Ky are set by simulation or experiments.

Also, in equation (4), in the case where the moving distance of the intruding object is (Δx, Δy)=(0, 0), i.e. in the case where the moving distance of the intruding object is zero, the zoom magnification rf is set to 1.5.

The zoom magnification rf, if increased to a predetermined value or more, for example, is adjusted to the particular predetermined value to prevent sharp zoom-in operation. The predetermined value may be 1.5, for example. In this case, the zoom-in up to a maximum of 50% is possible at a time.

Once the maximum zoom-in magnification rf (upper limit) per zoom-in session is set in this way, the problem is obviated that an object detected near the end of an input image, for example, is displaced out of the visual field on the image by the zoom-in operation.

It is also possible to use a configuration to use a variable upper limit of the zoom magnification rf. With this configuration, in the case where the template is too small as compared with the screen size of the input image, for example, the upper limit of the zoom magnification rf can be increased to more than Also, zoom-in operation may be limited based on the height of the template. For example, the zoom-in operation can be performed only in the range of the image screen height of not less than 120% of the template height. As an alternative, the zoom-in operation can be performed only when the width of the screen of the image is not less than 120% of the template width. As a result, the inconvenience can be prevented in which the moving distance (Δx, Δy) of the intruding object is so small that the template exceeds the screen size after a multiplicity of zoom-in operations. Thus, an image easy to view and a stable operation can be secured.

As another alternative, an upper limit may be set for the zoom-in operation based on the distances from the template to the upper end, the lower end, the left end and the right end, respectively, of the screen. For example, as shown in FIG. 12, the distance from the template 172 to the upper end, the lower end, the left end and the right end of the screen 171 are set at du, db, dl, dr, respectively, and the smallest one of the magnifications 120/(120−du), 120/(120−db), 160/(160−dl) and 160/(160−dr) at which the upper side, the lower side, the left side or the right side of the template 172 is displaced out of the screen by the zoom-in operation, except for negative values, is set as an upper limit of the zoom-in operation. In the process, the screen size of 320 pixels in horizontal direction and 240 pixels in vertical direction is assumed.

In predicting the moving distance of a target object, assuming that the distance covered by the target object in the preceding frame is (Δx′, Δy′), the magnification (the upper limit of the zoom-in magnification) at which the upper side, the lower side, the left side or the right side of the template is displaced out of the screen is calculated as 120/{120−(du+Δy′)}, 120/{120−(db−Δy′)}, 160/{160−(dl+Δx′)} or 160/{160−(dr−Δx′)}, respectively.

Also, the upper limit of the zoom-in magnification can be calculated based only on the shorter one of the distance du and db from the template 172 to the upper end and the lower end of the screen 171, respectively, or based only on the shorter one of the distance dl and dr from the template 172 to the left end and the right end of the screen 171.

In this way, the zoom magnification of the image pickup lens 201b is calculated based on the moving distance of the intruding object on the image, and in the camera head/lens control step 106, the focal length of the image pickup lens 201b is adjusted to f×rf through the lens control unit 202c.

The operation of controlling the image pickup lens 201b based on the moving distance of the intruding object on the image has been explained above. The process of steps 107 to 109 is similar to the corresponding process in the embodiment shown in FIG. 1 and therefore is not explained.

In the embodiment described above, the subtraction method is used for detecting an object from an image and the template matching method for detecting the moving distance of an object. As an alternative, any of other various methods may be used to track an intruding object while at the same time detecting the distance covered by the object as in the embodiment described above.

The invention has been described above with reference to embodiments, and it is apparent to those skilled in the art that various modifications and changes can be made without departing from the spirit and scope of the appending claims of the invention.

The object tracking apparatus and the image monitor device according to the invention are not necessarily limited to the configuration described above but various other configurations may be used.

Further, any of various types of lenses may be used other than the zoom lens which has been employed as an image pickup lens of an image pickup device according to the embodiments described above.

In the image pickup lens control step, the zoom magnification of the image pickup lens of the image pickup means can be calculated in such a manner that the size of the target object in the input image satisfies a predetermined range or that the moving distance of the target object in the image satisfies a predetermined range.

The partial image can be set by any of various methods. Also, the image enlarging means can be implemented by any of various means including electronic image enlarging means.

Further, the image pickup lens of the image pickup means can be controlled in any of various manners based on the detection result of the means for detecting the target object in the input image. Also, various methods are available for calculating the zoom magnification of the image pickup lens of the image pickup means based on the detection result of the means for detecting the target object in the input image.

Various methods are also usable for controlling the image pickup lens of the image pickup means based on the result of calculating the zoom magnification. The method in which the image pickup lens of the image pickup means is moved in such a manner as to realize the zoom magnification calculated is an example.

Also, the size of an object and the moving distance of the object in an image correspond to the size of the object and the moving distance of the object, respectively, in an image frame. As an example, the size of the object and the moving distance of the object in the image can be detected with the number of pixels making up the frame as a reference. The predetermined range of the size of the object in the image can be defined by various values, and can be set, for example, in such a way that the size of the object in the frame is not excessively large. Similarly, the predetermined range of the moving distance of the object in the image can be defined using various values, and can be set, for example, in such a way that the moving speed of the object in the frame is not excessively high.

This invention can be provided as a method or a system for executing the process of the invention or a program for implementing the particular method and system. Also, the invention can be provided as an object monitor device, an object detection apparatus, or any of various devices or systems.

The invention is applicable not only to the embodiments described above but also to various other fields.

In the object tracking apparatus and the image monitor device according to the invention, the various processes can be executed in a configuration controlled by a processor executing the control program stored in a ROM (read-only memory) in the hardware resources having the processor and a memory. As an alternative, a hardware circuit may be configured of independent means for performing various functions to execute a particular process.

This invention can be implemented also as a computer readable recording medium such as a flexible disk, a CD (compact disk), a ROM, a DVD (digital versatile disk) or a ROM storing the control program or the very control program. In such a case, the process of the invention can be executed by the processor in accordance with the control program input from the recording medium into the computer.

With the object tracking method and the object tracking apparatus according to the embodiments described above, an object in an image is tracked based on the image signal picked up by an image pickup device, by controlling the image pickup lens and electronically enlarging the image. In this way, the image of an object can be acquired with a sufficiently high resolution by following the motion of the object at a sufficiently high speed.

It should be further understood by those skilled in the art that although the foregoing description has been made on embodiments of the invention, the invention is not limited thereto and various changes and modifications may be made without departing from the spirit of the invention and the scope of the appended claims.

1. An object tracking method for tracking an object using an image pickup device with an imaging direction and zoom ratio thereof controllable, comprising the steps of:
detecting at least one feature amount of an image of said object within an input image obtained from said image pickup device;
controlling said image pickup device based on said at least one feature amount detected to track said object;
setting the range of a partial area including said image of said object within said input image based on said detected feature amount; and
enlarging an image in said set range of partial area.

2. An object tracking method according to claim 1,
wherein said at least one feature amount includes one of a position, size and moving distance of said object.

3. An object tracking method according to claim 2,
wherein the position of said range of partial area is set based on the position of the image of said object, and
wherein the size of said range of partial area is set based on the size of the image of said object.

4. An object tracking method according to claim 3,
wherein the image in said range of partial area is enlarged at a magnification rate set based on the size of said range of partial area and a predetermined image display size.

5. An object tracking method according to claim 3,
wherein a upper limit of a zoom amount of an image pickup lens of said image pickup device is set based on the size of the image of said object, wherein the size of said range of partial area is set to a preset ratio smaller than unity of the size of said input image.

6. An object tracking method according to claim 2,
wherein the zoom amount of said image pickup device is changed in dependence on the moving distance of the image of said object.

7. An object tracking method according to claim 2,
wherein said zoom amount of said image pickup device is changed in dependence on the size of the image of said object.

8. An object tracking apparatus comprising:
an image pickup device with the imaging direction and the zoom ratio thereof controllable;
a display unit;
a detection unit for detecting a feature amount of an image of said object within an input image obtained from said image pickup device;
a control unit for controlling said image pickup device based on said feature amount detected to track said object;
a setting unit for setting a range of a partial area including said object within said input image based on said feature amount; and
an enlarging unit for enlarging an image in said set range of partial area to be displayed on said display unit.

9. An object tracking apparatus according to claim 8,
wherein said feature amount includes at least one of a position, size and moving distance of said image of said object.

10. An object tracking apparatus according to claim 9,
wherein said setting unit sets a position of said range of partial area based on the position of the image of said object and sets a size of said range of partial area based on the size of said image of said object.

11. An object tracking apparatus according to claim 10,
wherein said enlarging unit enlarges an image in said range of partial area at a magnification rate set based on the size of said range of partial area and a predetermined image display size.

12. An object tracking apparatus according to claim 9,
wherein said control unit sets a upper limit of a zoom amount of an image pickup lens of said image pickup device based on the size of the image of said object, wherein the size of said range of partial area is set to a preset ratio smaller than unity of the size of said input image.

13. An object tracking apparatus according to claim 9,
wherein said control unit changes the zoom amount of said image pickup device in dependence on the moving distance of the image of said object.

14. An object tracking apparatus according to claim 9,
wherein said control unit changes said zoom amount of said image pickup device in dependence on the size of said image of said object

15. A computer program used to track an object by operating an object tracking apparatus having an image pickup device with an imaging direction and zoom amount thereof controllable, by executing the steps of:
detecting at least one feature amount of an image of said object within an image obtained from said image pickup device, said feature amount including at least one of a position, size and moving distance of the image of said object;
controlling said image pickup device based on said feature amount detected to track said object;
setting a range of a partial area including said image of said object within said input image based on said detected feature amount; and
enlarging an image in said set range of partial area.

16. A computer program according to claim 15,
wherein said step of setting said range of partial area includes setting the position of said range of partial area based on the position of the image of said object and setting the size of said range of partial area based on the size of the image of said object.

17. A computer program according to claim 15,
wherein said step of controlling said image pickup device includes setting a upper limit of a zoom amount of an image pickup lens of said image pickup device based on the size of the image of said object, wherein the size of said range of said partial area is set to a preset ratio smaller than unity of the size of said input image.

18. A computer program embodied on a computer-readable medium used to track an object by operating an object tracking apparatus having an image pickup device with an imaging direction and zoom amount thereof controllable, by executing the steps of:
detecting at least one feature amount of an image of said object within an input image obtained from said image pickup device, said feature amount including at least one of a position, size and the moving distance of said image of said object;
controlling said image pickup device based on said detected feature amount to track said object;
setting a range of a partial area including said image of said object within said input image based on said detected feature amount; and
enlarging the image in said set range of partial area.

19. A computer program according to claim 18,
wherein said step of setting said range of partial area includes setting a position of said range of partial area based on the position of the image of said object and also includes setting the size of said range of partial area based on the size of the image of said object.

20. A computer program according to claim 18,
wherein said step of controlling said image pickup device includes setting a upper limit of a zoom amount of an image pickup lens of said image pickup device based on the size of the image of said object, wherein the size of said range of partial area is set to a preset ratio smaller than unity of the size of said input image.
